(19) United States
(12) Patent Application Publication
(10) Pub. No.: US 2017/0330222 A1
(43) Pub. Date: Nov. 16, 2017

(54) Measuring the True Impact of an Ad, Commercial or FSI Coupon

(71) Applicant: Lee S. Weinblatt, Teaneck, NJ (US)

(72) Inventor: Lee S. Weinblatt, Teaneck, NJ (US)

(21) Appl. No.: 15/219,237

(22) Filed: Jul. 25, 2016

Related U.S. Application Data
(60) Provisional application No. 62/195,848, filed on Jul. 23, 2015.

(51) Int. Cl. G06Q 30/02; H04N 21/81

(52) U.S. Cl. CPC G06Q 30/0246; G06Q 30/0201; H04N 21/812

(57) ABSTRACT

A system for pre-testing advertisements commercials and coupons to determine their impact is on respondents. The system improves upon current existing forms of advertisement which are often inaccurate regarding users' true interests, and which do not make a respondent follow through with his or her answers, making it difficult to know if his or her answers are accurate. In the system, respondents are compelled to spend their free time reading further if they have real interest in the advertisement, and/or or to give information such as their email address or home address to get further information. This type of pre-testing allows a more accurate determination of whether respondents are truly interested in the goods or services in the advertisements that they are shown.

### RELATED APPLICATIONS

The present application claims the priority of U.S. Provisional Application No. 62/195,848 filed Jul. 23, 2015, which is fully incorporated herein by reference.

### FIELD OF THE INVENTION

The present inventions relate to apparatus and methods for measuring the true impact of an Ad, Commercial, or FSI Coupon on consumers by using a computerized system to see how much of their free time they are willing to spend exploring their interest.

### BACKGROUND OF THE INVENTION

Advertisers, broadcasters and governments all have a goal of reaching as many people as possible, with the right targeted advertisements that will catch their potential customers' and their citizens' attention, and persuade them into action. That is why, in the United States alone, interested parties spend more than $250 billion in advertising to try to reach and persuade a targeted group of people with their advertising materials.

One difficulty is that message transmission through traditional media no longer has the significant impact or reach that it used to. Message transmission is currently most popular through the Internet on computers, mobile devices and through television. New methods of advertisements are being developed to reach the masses as a replacement for the former advertisements long used on the radio, for example.

Moreover, new approaches are needed to determine which advertisements most appeal to people, get their attention, and persuade them. Current systems for pre-testing do not necessarily provide the level of confidence in their validity or accuracy that is needed by advertisers.

Currently, whether in a “natural” setting or a cluster of ads, respondents are asked to read a magazine, watch a program, look through a newspaper or examine a grouping of ads. Afterwards, respondents are asked for unaided and aided recall of the ad product's names, and whether they would consider purchasing the product or (for important decisions) whether they would ask their doctor or salesperson for more information.

The disadvantage of these current systems of pre-testing is that their accuracy can be extremely suspect. It is easy for a respondent to claim they would see a dealer (i.e. for a car or television set being offered) or would speak to their doctor (e.g. for more information on a DTC, or Direct-to-Customer, pharmaceutical). But there is no way of knowing if that is true and the individual really would do so. It is difficult to know whether the individual really would want more information, especially if it would take more of their time or if they have to give personal information to receive more information.

### SUMMARY OF THE INVENTION

In accordance with the present invention, a solution is provided for the problems and shortcomings of the current technology. As noted above, with current technology one can try to ask consumers questions regarding their interest in certain advertisements or coupons, but it is generally not an accurate determination of whether or not that consumer would really have interest in a natural real-world environment. As a result, in the present invention, a computer program is used to calculate how much interest a consumer is spending on a certain topic. This is done by measuring how much of the consumer's free time he or she is willing to spend on obtaining further information, and also how much personal information the consumer is willing to give in order to learn further about the product or service being advertised.

Thus, in accordance with the invention, by using a computer program with a special software that calculates consumers' interest by measuring the time and energy they spend on any given advertisement, it is possible to effectively measure consumer interest and achieve accurate results.

Measurement of consumer's interest in this way is more accurate because the consumer is not answering questions after having heard the radio, watched television, or seeing an ad on the internet. This is a live real world scenario where the consumer will show real interest by looking into the advertisement or product further, and possibly even give personal information to learn more. This is an accurate assessment of whether there is true interest on the part of the consumer. As a result, the present invention solves many of the shortcomings of the current technology, while creating a means of truly measuring an advertisement's effect on consumers.

### BRIEF DESCRIPTION OF THE DRAWINGS

FIG. 1 is a schematic in the form of a flow chart of one embodiment of the present invention.

### DETAILED DESCRIPTION OF THE INVENTION AND THE PREFERRED EMBODIMENTS

The present invention addresses these realities and overcomes the above disadvantages by fundamentally changing how information is gathered and marketing communications are pre-tested. The invention provides a solution for the problems and shortcomings of the current existing pre-testing technology.

In accordance with the invention, a system is provided where the respondent watches television with an ability to switch channels or read through a newspaper or magazine—each with numerous ads and without the respondent being told the true purpose of the test. This provides an environment most closely simulating the one in which the ads will be encountered in the real world.

Upon completion, each respondent is shown the names or pictures of the test product and competitors on a computer screen and asked if they would like to see more information. If they choose to click on a product picture, they will spend more of their free time now reading about it. These initial responses by the respondent provide some insight into their real level of interest.

The respondent is then shown the same names on a screen and asked if they would like information and/or a discount coupon to be sent to their homes or email address. If so, they then input their real home address and/or email address. This yet further provides insight into the respondent's true level of interest. In accordance with the preferred embodiments of the inventions, the extra information or coupons come from a second computer of the testing service (“in-house” computer”), and, therefore, does not require real websites or multiple brochures to be made for the test, especially if the test product has yet to come to market.

The advantage of the present invention is that this method of pre-testing is far more accurate in measuring the persuasive power of an ad than mere representations by a respondent. As the common saying goes, “talk is cheap.” It is easy to have a respondent agree that they think a given advertisement is persuasive and/or meaningful. However, “time is money.” A respondent who spends more of his or her free time to voluntarily read more about the product shows true interest. Likewise, “actions speak louder than words.” For a respondent to request that material be sent to his or her personal address means that the advertisement had real impact.

Thus, the present invention is able to assess respondents' true interest in advertisements and allows advertisers to use this information to come up with the best possible strategies to catch consumers' attention.

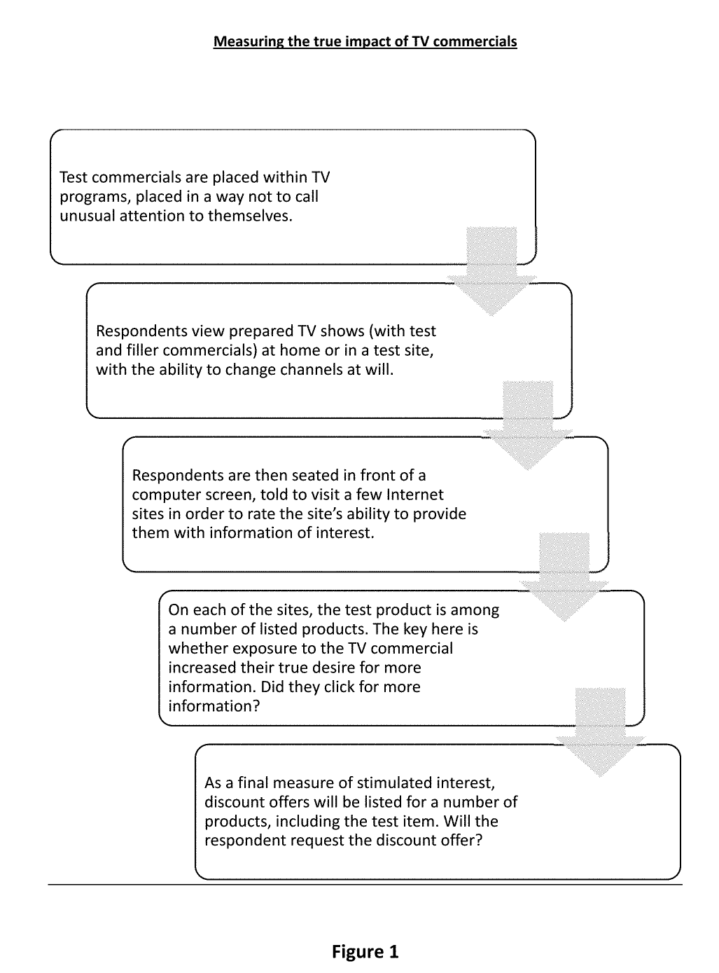

The method and system of the present inventions is a significant advantage over what currently exists to measure the true impact of a commercial. Simply asking respondents about the effectiveness of an ad after exposure to a commercial or ad has been found to be highly unpredictable of real world performance. As described for example, in FIG. 1, the present invention is able to more accurately measure whether people are interested in a given advertisement.

In accordance with the inventions, an example of the systems of the present invention is shown in FIG. 1. As indicated therein, in a first step, a testing agency or service, places one or more test commercials within TV programs or other media (whether internet or otherwise), the commercials preferably placed in a way to not call unusual attention to themselves.

In a second step, respondents view the prepared TV shows (with test and filler commercials) at home or in the test site, with the ability to change channels at will—supposedly for their review of the TV show of their choice. The computers of the present invention make sure the test commercial appears in the show of their selection.

Afterwards, in a third step, respondents are seated in front of a computer screen, and told to visit a few Internet sites in order to rate the site's ability to provide them with information of interest. On each of the sites, the test product is among a number of listed products.

In a fourth step, monitoring is conducted to answer the key question of whether exposure to the TV commercial increased the consumer's true desire for more information. In particular, the respondent is monitored to determined whether they clicked for more information.

As a final measure of stimulated interest, discount offers and/or promotional materials (such as giveaways, etc.) are listed for a number of products, including the test item. In a fifth step, the respondent is then monitored to determine whether he or she will request the discount offer. In an alternative or additional embodiment of the fourth step, the respondent is asked to give further information such as their email address or home address to get further information or to get offers such as discounts, and giveaways, and so forth.

The fourth and fifth steps can, of course, be conducted in either order. Likewise, either one, or both of, those steps can be conducted as part of a method and system consistent with the inventions.

In the fourth step, clicking for further information, and in the fifth step, requesting the discount offer or promotional materials, the consumer/test subject/respondent's actions provide valuable information regarding his or her true interest in a given advertisement. As opposed to traditional methods, the present inventions provide a more highly accurate means of testing the interest of consumers in promotional materials, such as advertisements, commercials, coupons, and other marketing.

The above description is considered that of certain embodiments of the present invention only. Modifications of the invention will occur to those skilled in the art and to those who make or use the invention. Therefore, it is understood that the embodiments described herein are merely for illustrative purposes only and are not intended to limit the scope of the invention.

What is claimed is:

1. A method for testing the impact of promotional materials, comprising the steps of:
a. placing a test commercial for a test product or service within media;
b. providing the media for a respondent to view at a test site, with the ability to change channels at will;
c. seating the respondent in front of a computer screen at the test site, and requesting that the respondent visit several Internet sites in order to rate the site's ability to provide them with information of interest, with the test product or service being among a number of listed products or services;
d. monitoring the respondent with a computer to determine whether he or she attempts to access further information regarding the test product or service; and,
e. monitoring the respondent with a computer to determine whether he or she requests that a discount offer be made available regarding the test product or service.

2. A method as claimed in claim 1, wherein the media is television programming.
